(19) United States
(12) Patent Application Publication
(10) Pub. No.: US 2014/0171029 A1
(43) Pub. Date: Jun. 19, 2014

(54) METHOD AND APPARATUS FOR AUTHENTICATING SUBSCRIBERS TO LONG TERM EVOLUTION TELECOMMUNICATION NETWORKS OR UNIVERSAL MOBILE TELECOMMUNICATIONS SYSTEM

(71) Applicant: Silke Holtmanns, Klaukkala (FI)

(72) Inventor: Silke Holtmanns, Klaukkala (FI)

(73) Assignee: Nokia Corporation, Espoo (FI)

(21) Appl. No.: 14/131,603

(22) PCT Filed: Jul. 8, 2011
(86) PCT No.: PCT/FI2011/050647

§ 371 Date: Jan. 8, 2014

(51) Int. Cl. H04W 12/04

(52) U.S. Cl. CPC H04W 12/04
USPC 455/411

(57) ABSTRACT

A method, apparatus and software for accessing a database having, for each of a plurality of subscribers of a mobile communication network, a long-term secret key shared between the subscriber and the apparatus, for network authentication of a mobile communication device to the mobile communication network; wherein the mobile communication network is a universal mobile telecommunications system or a long term evolution telecommunication network; and producing for the mobile communication device, the authentication of which is being verified, one or more authentication vectors compliant with the global system for mobile communications; each authentication vector comprising a challenge, a signed response and a session key; and containing in the authentication vector an integrity key and an authentication token.

### TECHNICAL FIELD

The present application generally relates to authenticating of subscribers to long term evolution telecommunication networks or universal mobile telecommunications system.

### BACKGROUND

Subscribers of mobile communication networks need to authenticate themselves to enable mobile communications. In Global System for Mobile communications (GSM), mobile phones have Subscriber Identity Modules (SIM) and the network has an Authentication Center (AuC) that together with the SIM takes care of producing cryptographic responses using which the phones authenticate themselves to the network. The authentication is needed to ensure the authenticity of any subscriber who tries to connect to a mobile communication network so as to avoid fraudulent acts. There are also various other kinds of mobile communication devices that use SIM cards such as universal serial bus (USB) sticks for computers that provide cellular network access using current supplied through a USB port.

In GSM, the authentication of subscribers is based on so-called authentication triplets, i.e. a challenge or random number RAND, session key Kc and signed response SRES. The subscriber receives the challenge and responsively returns a corresponding SRES the correctness of which proves that the response originates from a party who has access to a shared secret that is only known by the subscriber's SIM and by the AuC. Subsequently, the session key Kc can be used to encrypt communications between the subscriber and the network.

In a Universal Mobile Telecommunications System (UMTS), there are more sophisticated authentication schemes which not only enable authenticating a subscriber to a network but also authenticating of the network to the user. In the UMTS, each subscriber has a UICC card that holds a Universal Subscriber Identity Module (USIM) configured to operate with authentication quintets. The quintets are indirectly based on changing information elements SQN (incrementing sequence number) and anonymity key (AK) that are processed by the USIM.

Long term evolution (LTE) telecommunication networks also use authentication quintets similarly to the USIM for device authentication.

### SUMMARY

Various aspects of examples of the invention are set out in the claims.

According to a first example aspect of the present invention, there is provided an apparatus, comprising:

a communication control interface for causing a mobile communication device to receive a challenge from a network-based authentication unit, the mobile communication device being associated with a mobile communication subscription of a mobile communication network, for controlling the mobile communication device to authenticate to a universal mobile telecommunications system or to a long term evolution telecommunication network;

wherein the challenge corresponds to a signed response and to a session key that are compatible with global system for mobile communications; and the signed response and the session key are based on the challenge and on a shared secret known by the authentication unit and by a subscriber identity module that is configured to associate the mobile communication device with the subscription;

a radio management module configured to operate independently of the subscriber identity module and further configured to:
receive the challenge originated by the authentication unit and to provide the subscriber identity module with the challenge;
receive from the subscriber identity module a signed response and session key and cause sending of the received signed response to the network by the mobile communication device;
derive a key access security management entity compliant with authentication procedures of the universal mobile telecommunications system or with the long term evolution telecommunication network by a key derivation function from a plurality of input parameters which include directly or as derivatives an anonymity key and a sequence number; and
derive the anonymity key at least in part based on the session key received from the subscriber identity module.

The radio management module may be configured to operate independently of the subscriber identity module by using different processing circuitries.

The radio management module may be further configured to produce locally, for the calculation of the authentication response an evolved nodeB key, a local instance of the sequence number and an integrity key at least in part based on the session key.

The communication control interface may comprise a processor. The processor comprised by the communication control interface may be configured to also perform other functions for the mobile communication device.

The radio management module may comprise a processor. The processor comprised by the radio management module may be configured to also perform other functions for the mobile communication device.

The apparatus may comprise computer executable program code caused to control a processor, when executing the program code, to operate as the communication control interface.

The apparatus may comprise computer executable program code caused to control a processor, when executing the program code, to operate as the communication control interface.

The radio management module may be further configured to derive an authentication management field from the session key and signed response. Alternatively, the apparatus may be configured to enable storing of the authentication management field based on an auxiliary key management session. The auxiliary key management session may be performed using an internet based server.

The apparatus may further comprise a trusted platform module. The radio management module may be configured to store the authentication management field in the trusted platform module.

The radio management module may be further configured to derive an authentication management field from the session key and signed response.

The apparatus may be an integral part of the mobile communication device.

The apparatus and the subscriber identity module may be comprised by the mobile communication device.

The plurality of input parameters may comprise a function code.

The plurality of input parameters may comprise an identifier of the network.

The plurality of input parameters may comprise a length of the identifier of the network.

The radio management module may be configured to perform the producing of the authentication response based on the anonymity key and on the session key.

The sequence number may be a predetermined value. The predetermined value may be a constant such as zero. Alternatively, the radio management module may be further configured to maintain a local counter that holds a present sequence number corresponding to the operation known from the universal mobile telecommunications system.

The radio management module may be configured to compute the anonymity key with authentication function f5 known from the universal mobile telecommunications system from the session key and the challenge.

The radio management module may be configured to compute the integrity key with authentication function f4 known from the universal mobile telecommunications system from the session key and the challenge.

The radio management module may be configured to perform the producing of a local copy of the sequence number and of the anonymity key independent of the subscriber identity module.

The radio management module may be configured to perform verifying an authentication token received by the mobile communication device by:

deriving a message authentication code from the session key and from a stored authentication management field;

obtaining a message authentication code from the authentication token; and

accepting the authentication token if the derived message authentication code matches the obtained message authentication code.

According to a second example aspect of the present invention, there is provided a method comprising:

causing the mobile communication device to receive a challenge from a network-based authentication unit, the mobile communication device being associated with a mobile communication subscription of a mobile communication network, for controlling the mobile communication device to authenticate to a universal mobile telecommunications system or to a long term evolution telecommunication network;

wherein the challenge corresponds to a signed response and to a session key that are compatible with global system for mobile communications; and the signed response and the session key are based on the challenge and on a shared secret known by the authentication unit and by a subscriber identity module that is configured to associate the mobile communication device with the subscription;

independently of the subscriber identity module:
receiving the challenge originated by the authentication unit and providing the subscriber identity module with the challenge;
receiving from the subscriber identity module a signed response and session key and causing sending of the received signed response to the network by the mobile communication device;
deriving a key access security management entity compliant with authentication procedures of the universal mobile telecommunications system or with the long term evolution telecommunication network by a key derivation function from a plurality of input parameters which include directly or as derivatives an anonymity key and a sequence number; and
deriving the anonymity key at least in part based on the session key received from the subscriber identity module.

According to a third example aspect of the present invention, there is provided a computer program comprising:

code for causing the mobile communication device to receive a challenge from a network-based authentication unit, the mobile communication being device associated with a mobile communication subscription of a mobile communication network, for controlling the mobile communication device to authenticate to a universal mobile telecommunications system or to a long term evolution telecommunication network;

wherein the challenge corresponds to a signed response and to a session key that are compatible with global system for mobile communications; and the signed response and the session key are based on the challenge and on a shared secret known by the authentication unit and by a subscriber identity module that is configured to associate the mobile communication device with the subscription; independently of the subscriber identity module:

code for receiving the challenge originated by the authentication unit and providing the subscriber identity module with the challenge;

code for receiving from the subscriber identity module a signed response and session key and causing sending of the received signed response to the network by the mobile communication device;

code for deriving a key access security management entity compliant with authentication procedures of the universal mobile telecommunications system or with the long term evolution telecommunication network by a key derivation function from a plurality of input parameters which include directly or as derivatives an anonymity key and a sequence number; and

code for deriving the anonymity key at least in part based on the session key received from the subscriber identity module;

when the computer program is run on a processor.

According to a fourth example aspect of the present invention, there is provided an apparatus comprising:

a communication interface for accessing a database comprising, for each of a plurality of subscribers of a mobile communication network, a long-term secret key shared between the subscriber and the apparatus, for network authentication of a mobile communication device to the mobile communication network; wherein the mobile communication network is a universal mobile telecommunications system or a long term evolution telecommunication network; and

authentication vector generator configured to produce for the mobile communication device, the authentication of which is being verified, one or more authentication vectors compliant with the global system for mobile communications; each authentication vector comprising a challenge, a signed response and a session key;

wherein the authentication vector generator is further configured to contain in the authentication vector an integrity key and an authentication token.

The authentication vector generator may further be configured to derive the integrity key from the challenge and from the session key.

The apparatus may further comprise a verification module configured to: send a challenge from a given authentication vector to the mobile communication device;

receive a signed response from the mobile communication device responsively to the sending of the challenge; and

verify that the signed response received from the mobile communication device matches with the signed response that is contained by the given authentication vector.

The apparatus may further be configured to perform by either the authentication vector generator or by the verification module to:

produce a key access security management entity compliant with authentication procedures of the universal mobile telecommunications system or to the long term evolution telecommunication network by a key derivation function from a plurality of input parameters which include directly or as derivatives an anonymity key and a sequence number; and

derive the anonymity key at least in part based on the session key contained by the authentication vector.

The apparatus may further be configured to perform by either the authentication vector generator or by the verification module to produce the sequence number for producing of the authentication token.

The sequence number need not necessarily be specific to the mobile communication device. Instead, the sequence number may be a constant.

The apparatus may be configured to operate as a part of or as a companion of a home subscriber server.

The apparatus may be further configured to settle an initial sequence number with the mobile communication device using an off-band channel.

The apparatus may be further configured to settle an authentication management field with the mobile communication device using an off-band channel.

The off-band communication channel may refer to an internet connection made with a device other than the mobile communication device, a facsimile transmission, or a local connection such as a universal serial bus or infrared data transfer port connection.

According to a fifth example aspect of the present invention, there is provided a method comprising:

accessing a database comprising, for each of a plurality of subscribers of a mobile communication network, a long-term secret key shared between the subscriber and the apparatus, for network authentication of a mobile communication device to the mobile communication network; wherein the mobile communication network is a universal mobile telecommunications system or a long term evolution telecommunication network;

producing for the mobile communication device, the authentication of which is being verified, one or more authentication vectors compliant with the global system for mobile communications; each authentication vector comprising a challenge, a signed response and a session key; and

containing in the authentication vector an integrity key and an authentication token.

According to a sixth example aspect of the present invention, there is provided a computer program comprising:

code for accessing a database comprising, for each of a plurality of subscribers of a mobile communication network, a long-term secret key shared between the subscriber and the apparatus, for network authentication of a mobile communication device to the mobile communication network; wherein the mobile communication network is a universal mobile telecommunications system or a long term evolution telecommunication network;

code for producing for the mobile communication device, the authentication of which is being verified, one or more authentication vectors compliant with the global system for mobile communications; each authentication vector comprising a challenge, a signed response and a session key; and

code for containing in the authentication vector an integrity key and an authentication token;

when the computer program is run on a processor.

The computer program may be a computer program product comprising a computer-readable medium bearing computer program code embodied therein for use with a computer.

Any foregoing memory medium may comprise digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory.

The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows an architectural overview of a system of an example embodiment of the invention;

FIG. 2 shows a schematic signaling diagram of an authentication process of an example embodiment of the invention in the system of FIG. 1;

FIG. 3 shows a schematic drawing illustrating how an authentication vector is produced according to one example embodiment of the invention;

FIG. 4 shows a schematic block diagram of user equipment of an example embodiment of the invention; and

FIG. 5 shows a schematic block diagram of a server suited for operating as a mobility management entity or authentication center of an example embodiment of the invention.

### DETAILED DESCRIPTION OF THE DRAWINGS

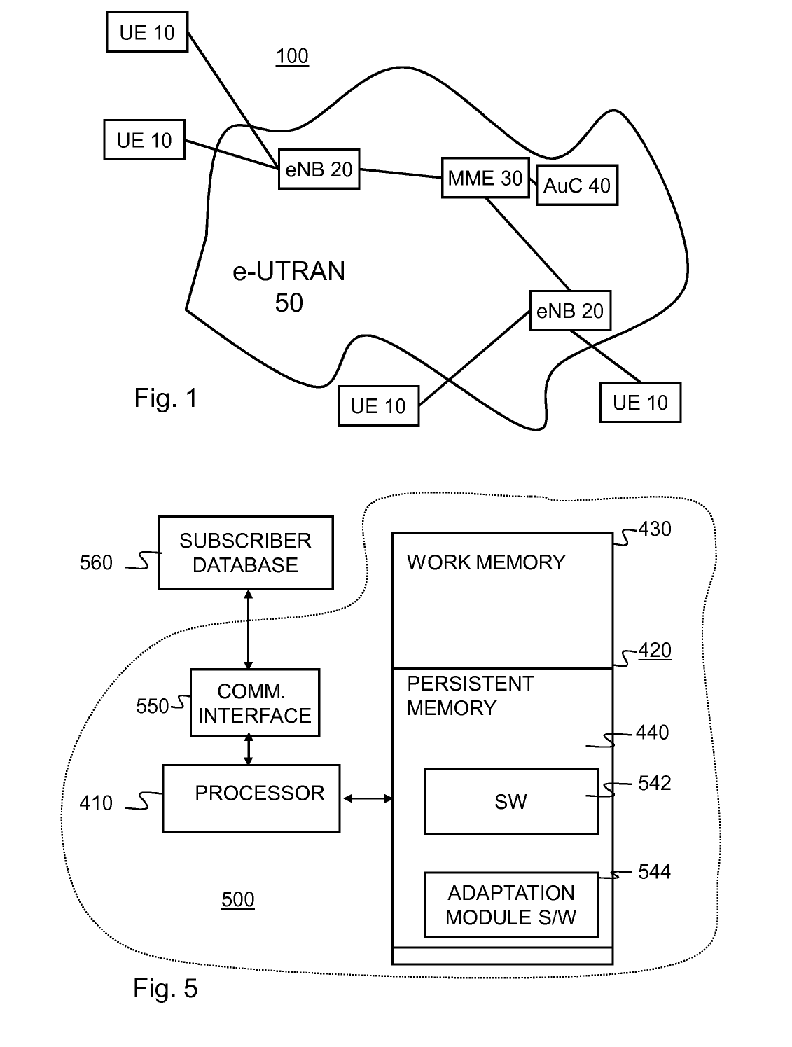

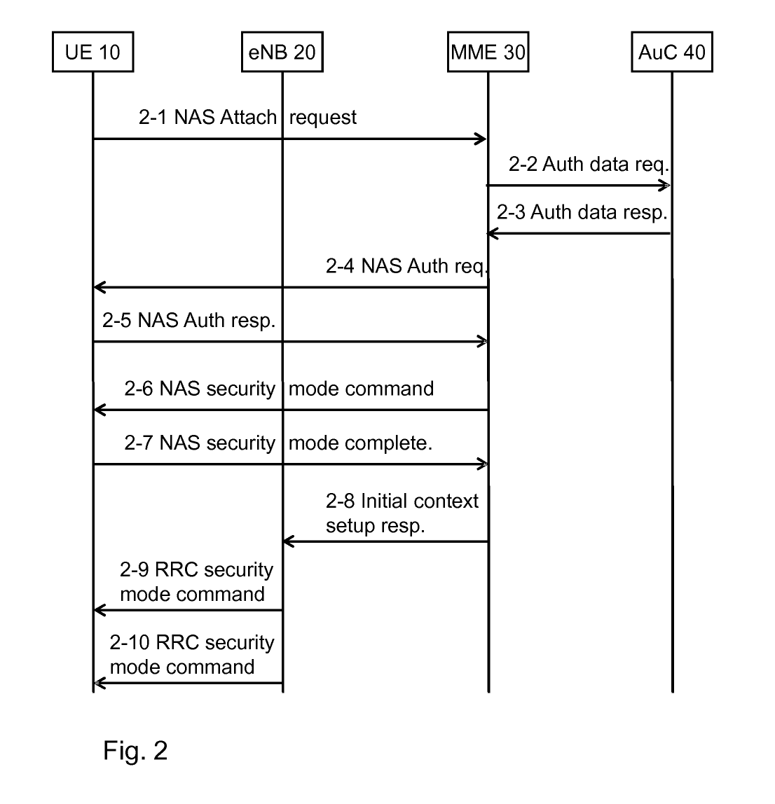

An example embodiment of the present invention and its potential advantages are understood by referring to FIGS. 1 through 4 of the drawings.

FIG. 1 shows an architectural overview of a system 100 of an example embodiment of the invention. The system 100 comprises a plurality of mobile communication devices or user equipment (UE) 10, a plurality of evolved node B elements (eNB) 20 that act as radio base stations for the user equipment 10, a mobility management entity (MME) 30, and an authentication unit such as an authentication center (AuC) 40.

The system 100 in this case is drawn in a simplistic manner to consist of a single radio network of only four UEs 10 and 2 eNBs 20. Of course, a single operator may have a number of radio networks of one or more different systems (e.g. Universal Mobile Telecommunications Systems, UMTS; Global System for Mobile communication, GSM; and Long Term Evolution telecommunication networks, LTE). In this description, let us assume that the network is a long term evolution network.

For associating a subscription with a UE 10, each UE 10 has a suited module for providing subscriber identification and authorization capabilities. GSM is by far the most largely deployed mobile communication system and single operators may hundreds of millions of GSM subscribers. These subscribers each have a subscriber identity module (SIM) card that is suited for sufficiently strong authentication to GSM networks. However, the LTE networks are designed to use stronger authentication that calls for more complex cards with which the base stations are also authenticated to the subscribers' user equipment 10.

There are also Removable User Identity Modules (R-UIM) and Universal Integrated Circuit Cards that enable operation with more than one telecommunication systems. These cards have more than one user identity applications and can run the user identity application needed for using a GSM, code division multiple access (CDMA) and even universal mobile telecommunications system (UMTS). These multi-system cards are yet more expensive and less widely deployed than the ordinary SIM cards, and the normal life time of the ordinary SIM card typically by far exceeds that of the mobile phones—in particular as people seek for better features by changing their phones. Hence, the inventor has realized that it would be very advantageous to enable the use of the present SIM cards in the new UMTS and LTE networks. There are two major hurdles, however: 1) the SIM cards do not support authenticating of the base station to the subscriber and thus it would be necessary to accept lower level of security in attaching users to the network. 2) the SIM cards do not support the authentication mechanism that is applied to authenticate a subscriber to the network. In particular, the SIM cards lack the capability of maintain a sequence number in synchrony with the authentication center 40. The sequence number is required for producing a security token called K_{ASME} i.e. a key access security management entity, which token is needed to derive the key used to secure future connection with the base station or with LTE nomenclature, with the evolved node B (eNB) 20. These issues are now resolved by different example embodiments described in the following.

For better explaining various example embodiments of the invention, it is useful to first describe with reference to FIG. 1 an authentication process of an example embodiment of the invention in the system of FIG. 1. When an LTE capable UE 10 armed with a SIM card desires to attach to an LTE network, the UE 10 first sends 2-1 a non-access stratum (NAS) attach request containing an international mobile subscriber identity (IMSI) to the mobility management entity 30. The mobility management entity 30 in turn sends an authentication data request 2-2 containing the IMSI to the AuC 40. The AuC detects, in one example embodiment, that the subscriber associated with this IMSI has a SIM card in use and directs that a process accordingly proceeds. The AuC should normally, in LTE subscriber authentication, send as an authentication data response 2-3, an authentication vector consisting of challenge (RAND), expected signed response (XRES), session key (cipher key CK), integrity key (IK) and authentication token (AUTN). The authentication token should be computed from a sequence number (SQN) that is combined by XOR-operation with an anonymity key (AK), an authentication management field (AMF), and a message authentication code (MAC). The message authentication code MAC is generated with K, SQN, RAND, and AMF, wherein K is the long term secret key shared by the subscriber's identity module and by the authentication center 40. The aforementioned anonymity key AK is derived in the LTE networks from the long-term secret key K. In this example embodiment now explained, the authentication center is aware that the UE 10 has no capability to maintain the SQN nor to verify the AUTN or to calculate an anonymity key AK using the long-term secret key K, because the SIM is not able to calculate the anonymity key nor will the SIM issue the long-term secret key to the UE 10.

Hence, the authentication center 40 produces a modified authentication vector that has the items that there should be in LTE networks, but the anonymity key AK and the integrity key IK are computed based using the session key Kc and the challenge RAND as inputs for respective key derivation functions.

Now, the MME receives the authentication vector in an authentication data response from the authentication center 2-3 and sends to the UE 10 an NAS authentication request 2-4 comprising the authentication token AUTN and the challenge RAND. Is shall be born in mind that the RAND is here the challenge for a GSM SIM. In response to receiving the NAS authentication request 2-4, the user equipment UE 10 passes the received RAND to its SIM, gets a corresponding signed response SRES and a session key Kc. The signed response is sent as a response RES to the MME 30 in a NAS authentication response 2-5. The MME 30 checks that the received response RES matched with that in the received authentication vector (XRES or expected response there). If no, the authentication fails; otherwise the MME 30 will calculate the necessary LTE networks' security parameters such as KASME, KeNB (cipher key for communications with the eNB 20) and send a NAS security mode command 2-6 to instruct the UE 10 of the security algorithms and various parameters to be used. The UE 10 calculates the corresponding security keys and replies with a NAS security mode complete message using the instructed security algorithms, with ciphering and integrity protection. In normal LTE networks, it is the USIM that calculates the necessary keys such as KASME and KeNB. In this example, however, there is an interfacing functionality such as a radio management module between the UE's radio part and the SIM that computes the necessary data for simulating the operation of a USIM for the UE 10.

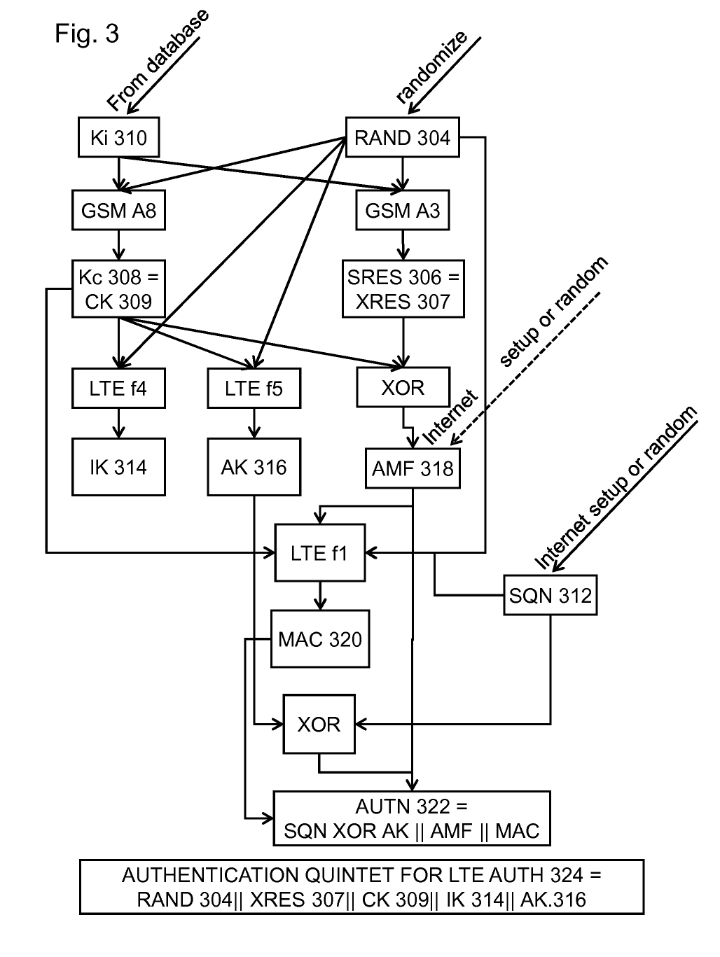

FIG. 3 shows a schematic drawing illustrating how an authentication vector 300 is produced according to one example embodiment of the invention. In this embodiment, this process takes place in the authentication center 40. It shall be appreciated, however, that the authentication center may be partly distributed and some or all of these functionalities may be performed by local or remote discrete entities.

First, a normal GSM authentication triplet 302 is formed, i.e. a challenge RAND 304 is produced by some random number generator and respective signed response SRES 306 and session key Kc 308 are derived using the subscriber's long term secret key Ki 310 that is also known to the authentication center 40.

For LTE authentication, there are various other parameters that are needed. A sequence number SQN 312 may be retrieved from a subscriber database or generated anew. Let us mention that it one example embodiment, the SQN 312 has to be first established in co-operation with the subscriber e.g. by registering to an internet account management service and there an initial SQN 312 is set. The user of the subscriber must then feed this initial SQN 312 to her UE's 10 radio management module e.g. using the user interface of the UE 10. The Internet account management service would register the initial SQN 312 e.g. to the subscriber database.

An integrity key IK 314 is derived not from the long-term secret key Ki 310 but from the session key Kc 308 using the authentication function f4 of the LTE.

An anonymity key AK 316 is derived not from the long-term secret key Ki but from the session key Kc 308 using the authentication function f5 of the LTE.

The session key Kc 308 is recorded as a ciphering key CK 309 of the LTE. Likewise, the challenge RAND 304 is recorded as the challenge of the LTE with like name (RAND) and the signed response SRES 306 is recorded as an expected response XRES 307 of the LTE. In the LTE, there is a second secret key shared by the USIM and the authentication center 40, the authentication management field AMF 318. As the GSM SIM does not support the AMF 318, we have to live without it or replace it with a key stored by the radio management module. In the foregoing, an embodiment was described for storing an initial sequence number SQN 312 using an Internet service. Likewise, the AMF 318 is obtained and stored in the radio management module in one example embodiment. In an alternative embodiment, the AMF 318 is substituted by a derivative of the session key Kc 308. For instance, the AMF 318 can be derived from the anonymity key AK 316 that is already derived from the session key Kc 308 with a cryptographic function or by using some non-cryptographic function such as XOR to combine the session key Kc 308 with another key that is based on the long-term secret key Ki 310, such as the signed response SRES 306. In FIG. 3, the AMF 318 is derived by XOR from the session key Kc 308 and the SRES 306. If both the Kc 308 or SRES 306 are shorter than the AMF in the LTE, then one or both of these input parameters are padded by constant bits in one example embodiment.

It is appreciated that in some example embodiments, the AMF 318 and SQN 312 counter are simulated and thus also the network can be authenticated to the UE 10.

It is also appreciated that in all the example embodiments described in the foregoing, the radio management module together simulates the operation of a universal subscriber identity module USIM with modifications that are transparent to the radio network provided that the authentication center 40 supports these modifications. Hence, the UE 10 can also roam in foreign networks that support the LTE.

A message authentication code MAC 320 is generated with function f1 of the LTE from inputs Kc, SQN, RAND, and AMF. Notice, that as the SIM card is unable to produce the MAC, we use the session key Kc 308 as a substitute for secret key Ki 310.

An authentication token AUTN 322 is derived as: SQN XOR AK ∥ AMF ∥ MAC, all of these parameters being introduced in the foregoing. Denotation ∥ represents string concatenation.

We now have all the necessary data elements to derive an authentication quintet 324 that complies with the LTE. The quintet 324 is as follows: RAND ∥ XRES ∥ CK ∥ IK ∥ AK.

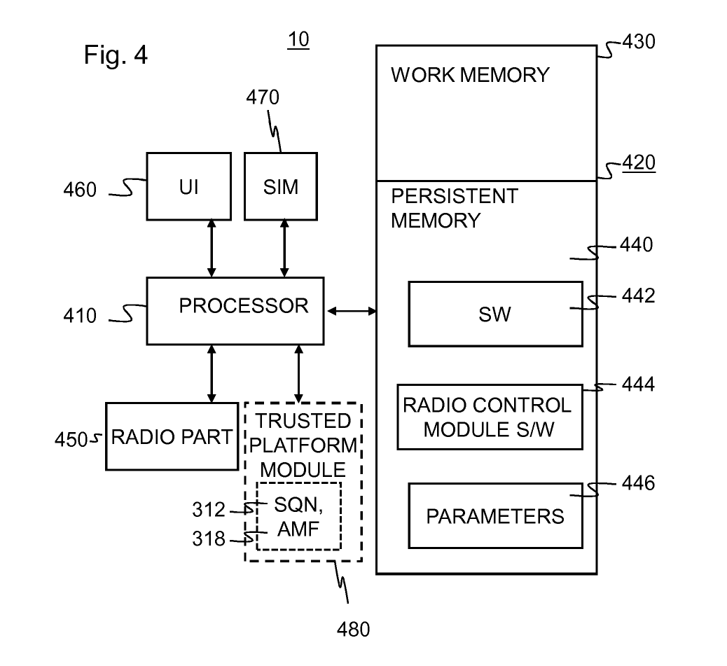

FIG. 4 shows a schematic block diagram of an apparatus that is user equipment 10 of an example embodiment of the invention. The UE 10 comprises a radio part 450 that has typical baseband and radio frequency circuitries for communications in LTE networks, a user interface 460, a processor 410 coupled to the radio part 450, a trusted platform module (TPM) 480 to which the processor is also coupled and a memory 420 coupled to the processor 410. Notice that in this document, unless otherwise stated, coupling refers to logical or functional coupling and there may be various intermediate components and circuits such as application specific integrated circuits, buses etc. between the different components. The UE 10 further comprises a memory 420 that comprises a work memory 430 or random access memory and a persistent memory 440. The persistent memory stores software 442 that is operable to be loaded into and executed in the processor 410. In an example embodiment, the software 442 comprises one or more software modules.

The user interface 460 comprises various input and/or output transducers suited to input and/or output one or more of the following: tactile feedback such as vibration, audible feedback, visible feedback, spoken input, gesture input, key actuation touch on a screen, or any combination thereof. In one example embodiment mentioned in the foregoing, the UE 10 forms an internet connection to a site that enables the UE 10 and the authentication center to record the AMF 318 and an initial value for the SQN 312. For that example embodiment, the UI 460 may comprise, for instance, a display and a keypad. However, it is appreciated that the UE 10 need not be a portable phone, but the UE 10 may be embodied in a large variety of ways, including as a USB stick, communication part of a vending machine or of a vehicle, tablet computer, electronic book, digital camera with capability to upload shots and navigation device.

The trusted platform module 480 is an entity that is used in some example embodiments to store information that is needed to emulate the operation of a USIM, such as the SQN 312 and the AMF 318 as also drawn in FIG. 4. In the trusted platform module 480, the stored data may be so stored that user and user installed applications have no access to these stored data. Also the trusted platform module 480 may keep these stored data safe from overwriting or deleting by the user or other applications.

The processor 410 is, e.g., a central processing unit (CPU), a microprocessor, a digital signal processor (DSP), a graphics processing unit, an application specific integrated circuit (ASIC), a field programmable gate array, a micro apparatus 400 or a combination of such elements. FIG. 4 shows one processor 410. In some embodiments, the apparatus 400 comprises a plurality of processors.

The memory 420 is, for example, a volatile or a non-volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The UE 400 comprises one or more memories. The memory 420 is constructed as a part of the apparatus 400 in one embodiment. In another embodiment, the memory 420 is inserted into a slot, or connected via a port, or the like of the apparatus 400. In one embodiment, the memory 420 serves the sole purpose of storing data. In an alternative embodiment, the memory 420 is constructed as a part of an apparatus serving other purposes, such as processing data.

The persistent memory 440 of FIG. 4 stores also radio management module software 444 that is configured to cause the processor 410 to implement a software based radio management module. The persistent memory 440 of FIG. 4 also stores, in some example embodiments, also parameters 446 used in the authentication of the UE 10 to the LTE network. For instance, parameters that need not survive over long periods such as the session key Kc 308, SRES 306, CK 309, IK 314, AK 316 and the MAC may be stored as the parameters 446.

FIG. 5 shows a schematic block diagram of an apparatus 500 suited for operating as suited for operating as a mobility management entity 30 or as an authentication center 40 of an example embodiment of the invention. The apparatus comprises similar functions as the UE 10 such as the processor, memory 420 with a work memory 430 and persistent memory 440. Of course, these elements are typically more powerful than those of a UE 10, but their implementation is largely similar to that described in the foregoing and need not be repeated here. The apparatus 500 comprises computer readable program code in software 542 that is configured to cause the processor 410 to control the operation of the apparatus according to the program code. The persistent memory is also drawn to comprise a separate adaptation module software 544. This is so for reasons of describing some example embodiments; in practice, neither FIG. 5 nor FIG. 4 apparata need not have two different pieces of software, but one software suited to perform both functions. The adaptation module software contains operation instructions for controlling the processor to perform those operations that are deviant from a normal mobility management entity 30 or authentication server 40 as the case may be. FIG. 5 also depicts a subscriber database 560 outside the apparatus 500 to which database the processor has an access through a communication interface 550. The adaptation module software may be suited to make the processor 410 to operate as an authentication vector generator. Alternatively, the authentication vector generator may be based on hardwired circuitry or other dedicated software and circuitry The communication interface may comprise a local bus such as a universal serial bus, IEEE-1394, Small Computer System Interface (SCSI), Ethernet, optical communication port, or the like.

Without in any way limiting the scope, interpretation, or application of the claims appearing below, a technical effect of one or more of the example embodiments disclosed herein is that the large existing based of SIM cards can be used for authenticating user equipment to mobile communication networks that are not designed to operate with SIM cards. Another technical effect of one or more of the example embodiments disclosed herein is that authentication of a user equipment can be arranged in both home and foreign networks as radio network implementation need not be changed to enable the use of SIM cards. Another technical effect of one or more of the example embodiments disclosed herein is that all normal authentication and ciphering procedures of LTE networks can be applied with a SIM card and without use of a more evolved user identity module.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of such apparata being described and depicted in FIGS. 4 and 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-39. (canceled)

40. An apparatus, comprising:
a communication control interface for causing a mobile communication device to receive a challenge from a network-based authentication unit, the mobile communication device being associated with a mobile communication subscription of a mobile communication network, for controlling the mobile communication device to authenticate to the mobile communication network;
wherein the challenge corresponds to a signed response and to a session key that are compatible with global system for mobile communications; and the signed response and the session key are based on the challenge and on a shared secret known by the authentication unit and by a subscriber identity module configured to associate the mobile communication device with the subscription;
a radio management module configured to operate independently of the subscriber identity module and that is further configured to:
receive the challenge originated by the authentication unit and to provide the subscriber identity module with the challenge;
receive from the subscriber identity module a signed response and session key and cause sending of the received signed response to the authentication unit by the mobile communication device;
derive a key access security management entity compliant with authentication procedures of the mobile communication network by a key derivation function from a plurality of input parameters which include directly or as derivatives an anonymity key and a sequence number; and
derive the anonymity key at least in part based on the session key received from the subscriber identity module.

41. The apparatus of claim 40, wherein the radio management module is further configured to derive an authentication management field from the session key and signed response.

42. The apparatus of claim 40, further comprising a trusted platform module.

43. The apparatus of claim 42, further configured to store the authentication management field in the trusted platform module.

44. The apparatus of claim 42, further configured to store the sequence number in the trusted platform module.

45. The apparatus of claim 40, wherein the radio management module is further configured to maintain a local counter that holds a present sequence number in compliance with the universal mobile telecommunications system.

46. The apparatus of claim 40, wherein the radio management module is further configured to derive the anonymity key with an authentication function known from the universal mobile telecommunications system from the session key and the challenge.

47. The apparatus of claim 40, wherein the radio management module is configured to compute an integrity key with an authentication function of the universal mobile telecommunications system from the session key and the challenge.

48. The apparatus of claim 40, wherein the communication control interface comprises a processor.

49. The apparatus of claim 40, wherein the radio management module comprises a processor.

50. The apparatus of claim 40, wherein the apparatus is an integral part of the mobile communication device.

51. A method comprising:
causing a mobile communication device to receive a challenge from a network-based authentication unit, the mobile communication device being associated with a mobile communication subscription of a mobile communication network, for controlling the mobile communication device to authenticate to the mobile communication network;
wherein the challenge corresponds to a signed response and to a session key that are compatible with global system for mobile communications; and the signed response and the session key are based on the challenge and on a shared secret known by the authentication unit and by a subscriber identity module that is configured to associate the mobile communication device with the subscription;
independently of the subscriber identity module:
receiving the challenge originated by the authentication unit and providing the subscriber identity module with the challenge;
receiving from the subscriber identity module a signed response and session key and causing sending of the received signed response to the network by the mobile communication device;
deriving a key access security management entity compliant with authentication procedures of the mobile communication network by a key derivation function from a plurality of input parameters which include directly or as derivatives an anonymity key and a sequence number; and
deriving the anonymity key at least in part based on the session key received from the subscriber identity module.

52. The method of claim 51, further comprising deriving an authentication management field from the session key and signed response.

53. The method of claim 52, further comprising storing the authentication management field in a trusted platform module of the mobile communication device.

54. The method of any of claim 53, wherein further comprising storing the sequence number in the trusted platform module.

55. An apparatus comprising:
a communication interface for accessing a database comprising, for each of a plurality of subscribers of a mobile communication network, a long-term secret key shared between the subscriber and the apparatus, for network authentication of a mobile communication device to the mobile communication network; wherein the mobile communication network is a universal mobile telecommunications system or a long term evolution telecommunication network; and
authentication vector generator configured to produce for the mobile communication device, the authentication of which is being verified, one or more authentication vectors compliant with the global system for mobile communications; each authentication vector comprising a challenge, a signed response and a session key;
wherein the authentication vector generator is further configured to contain in the authentication vector an integrity key and an authentication token.

56. The apparatus of claim 55, wherein the authentication vector generator is further configured to derive the integrity key from the challenge and from the session key.

57. The apparatus of claim 55, further configured to perform by either the authentication vector generator or by the verification module:
producing a key access security management entity compliant with authentication procedures of the universal mobile telecommunications system or to the long term evolution telecommunication network by a key derivation function from a plurality of input parameters which include directly or as derivatives an anonymity key and a sequence number; and
deriving the anonymity key at least in part based on the session key contained by the authentication vector.

58. The apparatus of claim 55, further configured to perform by either the authentication vector generator or by the verification module producing the sequence number for producing of the authentication token.

59. The apparatus of claim 58, wherein the sequence number is neither specific to the mobile communication device nor to a subscriber identity module associated with the mobile communication device.

60. The apparatus of claim 55, wherein the apparatus is further configured to settle an initial sequence number or an authentication management field with the mobile communication device using an off-band channel.
